(19) United States
(12) Patent Application Publication
(10) Pub. No.: US 2024/0080398 A1
(43) Pub. Date: Mar. 7, 2024

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Nagamasa MISU, Kanagawa (JP); Masahiko MIZUMURA, Kanagawa (JP); Seiji SHIRAKI, Kanagawa (JP); Yushiro TANAKA, Kanagawa (JP)

(73) Assignee: FUJIFILM Business Innovation Corp., Tokyo (JP)

(21) Appl. No.: 18/184,001

(22) Filed: Mar. 15, 2023

(30) Foreign Application Priority Data
Sep. 5, 2022 (JP) 2022-140671

(51) Int. Cl. H04N 1/00; G06V 30/414

(52) U.S. Cl. CPC H04N 1/00816; G06V 30/414; H04N 1/00806

(57) ABSTRACT

An information processing apparatus includes a processor configured to: obtain plural page images obtained by reading pages; identify, in two page images that are target pages among the plural page images, a torn part in edge parts adjacent to each other when the target pages are two facing pages that show one image; and detect and output the two facing pages by using an obtained result of identification.

### CROSS-REFERENCE TO RELATED APPLICATIONS

This application is based on and claims priority under 35 USC 119 from Japanese Patent Application No. 2022-140671 filed Sep. 5, 2022.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 2015-216551 discloses an image forming apparatus including a detection processing region determination unit 501 that determines a region for which a double-spread determination process is performed for image data obtained by reading a book that is ripped apart, a two-facing-pages detection processing unit 502 that detects pages forming a double spread, and a post-detection processing unit 503 that performs a process after the two-facing-pages detection process so as to allow the two facing pages to be viewed at once when viewed as an e-book.

### SUMMARY

A technique is available in which page images of a document including plural sheets are obtained by reading the document with a reading function of an image forming apparatus or the like, two facing pages that show one image spreading over two sheets of the document are detected from the page images, and the two facing pages are combined and output as image data. For example, an image forming apparatus that uses read page images to determine whether target pages corresponding to two page images are pages facing each other, by comparing their edge parts adjacent to each other.

To read a book or the like as page images, the book is ripped apart in advance into pages. During ripping, an edge part of a page may be torn.

When a document having a torn edge part is read, pages actually facing each other might not be output as two facing pages.

Aspects of non-limiting embodiments of the present disclosure relate to providing an information processing apparatus and an information processing program that enable output of two facing pages even when a document having a torn edge part is read.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: obtain a plurality of page images obtained by reading pages; identify, in two page images that are target pages among the plurality of page images, a torn part in edge parts adjacent to each other when the target pages are two facing pages that show one image; and detect and output the two facing pages by using an obtained result of identification.

### BRIEF DESCRIPTION OF THE DRAWINGS

Exemplary embodiments of the present disclosure will be described in detail based on the following figures, wherein:

FIG. 1 is a schematic diagram illustrating an example of an information processing system according to exemplary embodiments;

FIG. 2 is a block diagram illustrating an example hardware configuration of an information processing apparatus according to the exemplary embodiments;

FIG. 3 is a block diagram illustrating an example functional configuration of the information processing apparatus according to a first exemplary embodiment;

FIG. 4 is a schematic diagram illustrating example page images referred to in explanation of target pages according to the first exemplary embodiment;

FIG. 5 is a schematic diagram illustrating the example page images referred to in explanation of edge parts according to the first exemplary embodiment;

FIG. 6 is a schematic diagram illustrating the example page images referred to in explanation of segmented regions according to the first exemplary embodiment;

FIG. 7 is a flowchart illustrating an example flow of information processing according to the first exemplary embodiment;

FIG. 8 is a schematic diagram illustrating the example page images referred to in explanation of segmented regions according to a second exemplary embodiment;

FIG. 9 is a flowchart illustrating an example flow of information processing according to the second exemplary embodiment;

FIG. 10 is a block diagram illustrating an example functional configuration of the information processing apparatus according to a third exemplary embodiment;

FIG. 11 is a schematic diagram illustrating the example page images referred to in explanation of compensating for a torn part according to the third exemplary embodiment; and

FIG. 12 is a flowchart illustrating an example flow of information processing according to the third exemplary embodiment.

### DETAILED DESCRIPTION

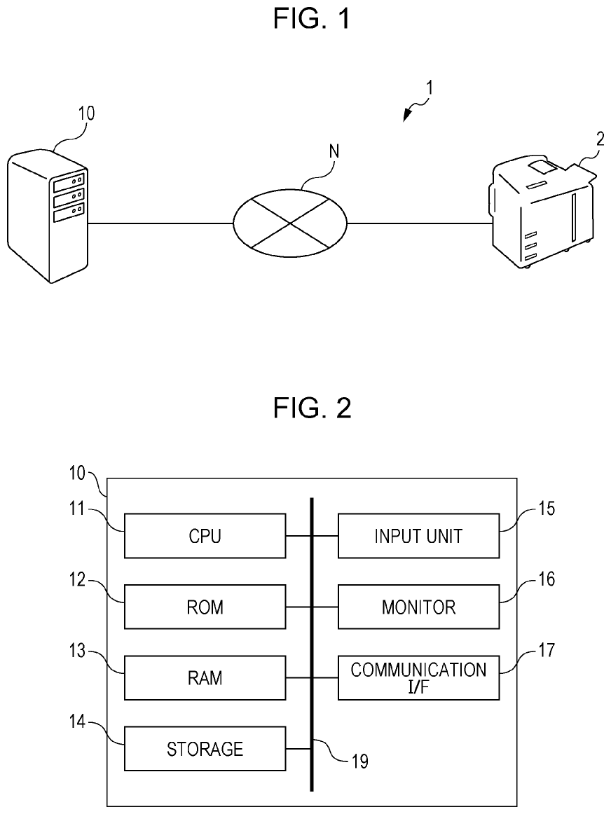

Hereinafter, exemplary embodiments of the present disclosure will be described in detail with reference to the drawings. FIG. 1 is a schematic diagram illustrating an example configuration of an information processing system 1 according to the exemplary embodiments.

FIG. 1 illustrates an example where the information processing system 1 includes a multifunction peripheral 2 and an information processing apparatus 10. The multifunction peripheral 2 and the information processing apparatus 10 are connected to each other via a network N.

The multifunction peripheral 2 is an image forming apparatus having an image reading function, an image printing function, and an image transmitting function. The multifunction peripheral 2 performs, for example, a process of transmitting to the information processing apparatus 10 images (hereinafter referred to as “page images”) obtained by reading pages of a document, a book, or the like, in accordance with a user instruction.

The information processing apparatus 10 is a server, such as a personal computer, that performs, in accordance with a user instruction, a process of detecting page images corresponding to two facing pages among plural page images obtained from the multifunction peripheral 2. A form in which the information processing apparatus 10 according to the exemplary embodiments is a server will be described. However, the information processing apparatus 10 is not limited to this form. The information processing apparatus 10 may be a terminal. The information processing apparatus 10 may be installed in the multifunction peripheral 2. A form in which two facing pages according to the exemplary embodiments are two pages that show one image spreading over the pages will be described.

Now, a hardware configuration of the information processing apparatus 10 will be described with reference to FIG. 2.

FIG. 2 illustrates an example where the information processing apparatus 10 according to the exemplary embodiments includes a central processing unit (CPU) 11, a read-only memory (ROM) 12, a random access memory (RAM) 13, a storage 14, an input unit 15, a monitor 16, and a communication interface (communication I/F) 17. The CPU 11, the ROM 12, the RAM 13, the storage 14, the input unit 15, the monitor 16, and the communication OF 17 are connected to each other by a bus 19.

The CPU 11 centrally controls the information processing apparatus 10 as a whole. The ROM 12 stores various programs, data, and so on. The RAM 13 is a memory used as a work area during execution of various programs. The CPU 11 loads a program stored in the ROM 12 to the RAM 13 and executes the program to thereby perform a process of detecting two facing pages.

The storage 14 is, for example, a hard disk drive (HDD), a solid state drive (SSD), or a flash memory. In the storage 14, various programs and so on may be stored.

The input unit 15 includes a keyboard, a pointing device, and so on that accept, for example, input of text and selection of an image. The monitor 16 displays text and images. The communication OF 17 is used to transmit and receive data.

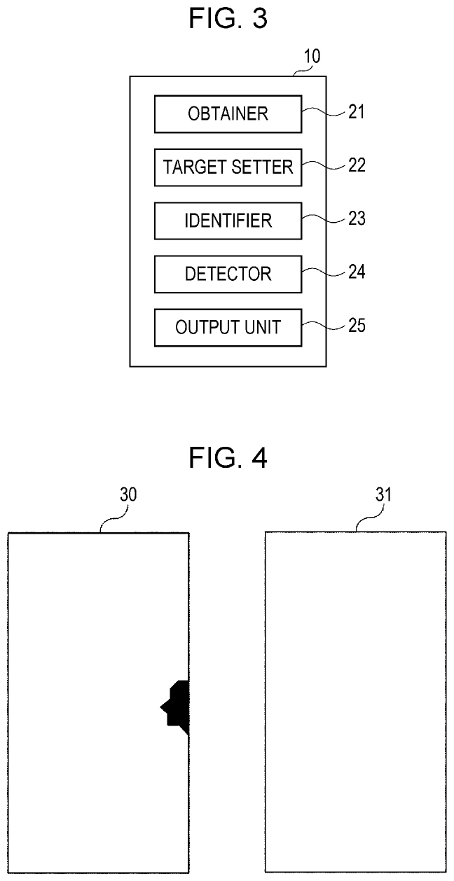

Now, a functional configuration of the information processing apparatus 10 will be described with reference to FIG. 3. FIG. 3 is a block diagram illustrating an example functional configuration of the information processing apparatus 10 according to a first exemplary embodiment.

FIG. 3 illustrates an example where the information processing apparatus 10 includes an obtainer 21, a target setter 22, an identifier 23, a detector 24, and an output unit 25. The CPU 11 executes an information processing program to thereby function as the obtainer 21, the target setter 22, the identifier 23, the detector 24, and the output unit 25.

The obtainer 21 obtains plural page images received from the multifunction peripheral 2 and obtained by reading pages of a book or the like.

The target setter 22 sets two page images among the obtained page images as target pages from which two facing pages are to be detected. Here, a form will be described in which target pages according to this exemplary embodiment are candidate two facing pages and correspond to page images in which the two page images are arranged side by side so as to be simultaneously visible.

FIG. 4 illustrates an example where, when two page images of target pages are arranged side by side, the two facing pages include a left-side page of the two facing pages (hereinafter referred to as “left-hand page”) 30 and a right-side page thereof (hereinafter referred to as “right-hand page”) 31.

For example, the target setter 22 sets the page image of the first page among the obtained page images as the left-hand page 30, and sets each of the other page images of the second and subsequent pages as the right-hand page 31 in a sequential manner to thereby check all combinations of the obtained page images and detect two facing pages. When the detection process for the first page is completed, the target setter 22 sets the page image of the second page as the left-hand page 30, and sets each of the page images of pages other the second page as the right-hand page 31 in a sequential manner to thereby detect two facing pages.

In this exemplary embodiment, a form in which two facing pages are detected from all combinations of page images as target pages has been described. However, the target pages are not limited to this form. For example, a combination of pages adjacent to each other may be set as target pages. In a case of a book or the like read by turning the pages to the right (bound on the right side), as the target pages, an odd-numbered page in the page images may be set as the left-hand page and an even-numbered page in the page images may be set as the right-hand page, and in a case of a book or the like read by turning the pages to the left (bound on the left side), as the target pages, an even-numbered page in the page images may be set as the left-hand page and an odd-numbered page in the page images may be set as the right-hand page. That is, page images may be set in accordance with the preset direction in which the pages are turned (the side of binding).

The identifier 23 identifies a torn part from a region corresponding to the binding margins of two facing pages. Specifically, in two page images, among the obtained page images, corresponding to target pages from which two facing pages are to be detected, the identifier 23 identifies a torn part in edge parts adjacent to each other when the target pages are two facing pages showing one image.

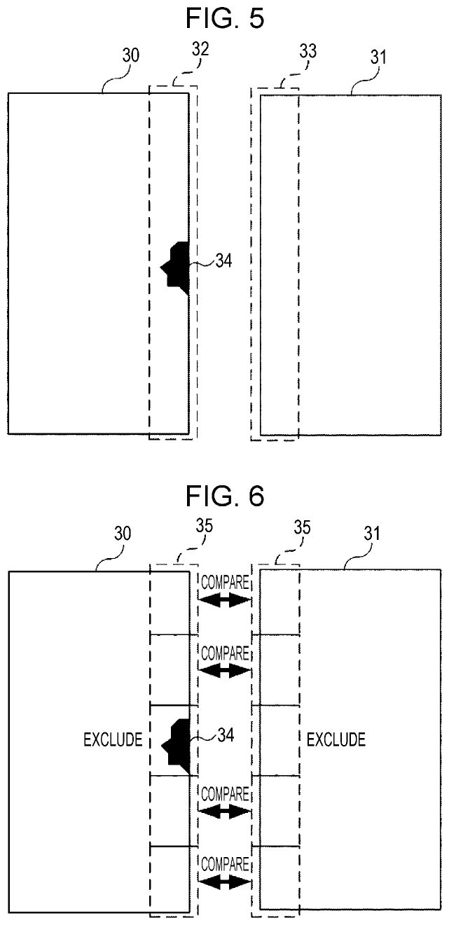

FIG. 5 illustrates an example where the identifier 23 sets a predetermined region extending from the right edge of the left-hand page 30 (hereinafter referred to as “right-edge region”) 32 as a target region for which a torn part is to be identified. The identifier 23 sets a predetermined region extending from the left edge of the right-hand page 31 (hereinafter referred to as “left-edge region”) 33 as a target region for which a torn part is to be identified. The identifier 23 identifies a torn part 34 in the page images from the right-edge region 32 and the left-edge region 33. Here, a torn part includes a part that is in an edge part of a page image and in which the outline of the page image is lost and a part that is in an edge part of a page image and in which a feature value related to a predetermined color is detected. A feature value related to a color is related to the color (for example, white or black) of the back of the take-in part of the multifunction peripheral 2, the back of the take-in part being included in the image when the page is taken in, and a part in which a feature value related to a predetermined color is detected is a part in which the area of a region that is in the color of the back is larger than a predetermined area.

The identifier 23 detects a part in which the outline is lost and a part in which a feature value related to the predetermined color is detected to thereby identify the torn part 34. Here, the identifier 23 identifies a page image in which the torn part 34 is present and the position (coordinates) of the torn part 34 in the page image, as the result of identification. A form in which the torn part 34 according to this exemplary embodiment includes a part in which the outline is lost and a part in which a feature value related to the predetermined color is detected has been described. However, the torn part 34 is not limited to this form. The torn part 34 may be a part in which the outline is lost or a part in which a feature value related to the predetermined color is detected. The user may select as the torn part 34, at least one of a part in which the outline is lost or a part in which a feature value related to the predetermined color is detected.

The detector 24 uses the result of identification obtained by the identifier 23 to detect two facing pages from the target pages. FIG. 6 illustrates a specific example where the detector 24 segments each of the right-edge region 32 and the left-edge region 33 into a predetermined number of segmented regions 35 and compares the right-edge region 32 and the left-edge region 33 with each other for each set of segmented regions 35.

For each segmented region 35, the detector 24 derives the average of the pixel values of pixels included in the segmented regions 35 and derives the difference between the average for the segmented region 35 in the right-edge region 32 and the average for the segmented region 35 in the left-edge region 33 corresponding to each other to thereby compare the segmented regions 35. When the torn part 34 is included in the segmented region 35 in the right-edge region 32 or in the left-edge region 33, the detector 24 excludes the segmented regions 35 in the right-edge region 32 and the left-edge region 33 from comparison targets.

When the derived difference is less than a predetermined threshold (hereinafter referred to as “difference threshold”), the detector 24 determines that the segmented region 35 in the right-edge region 32 and the segmented region 35 in the left-edge region 33 match each other. The detector 24 compares each set of corresponding segmented regions 35 in the right-edge region 32 and the left-edge region 33, and when the number of sets of segmented regions that match each other is greater than a predetermined number (hereinafter referred to as “matching threshold”), detects the target pages as two facing pages.

The output unit 25 combines the page images detected as two facing pages and outputs the two facing pages together with the page images.

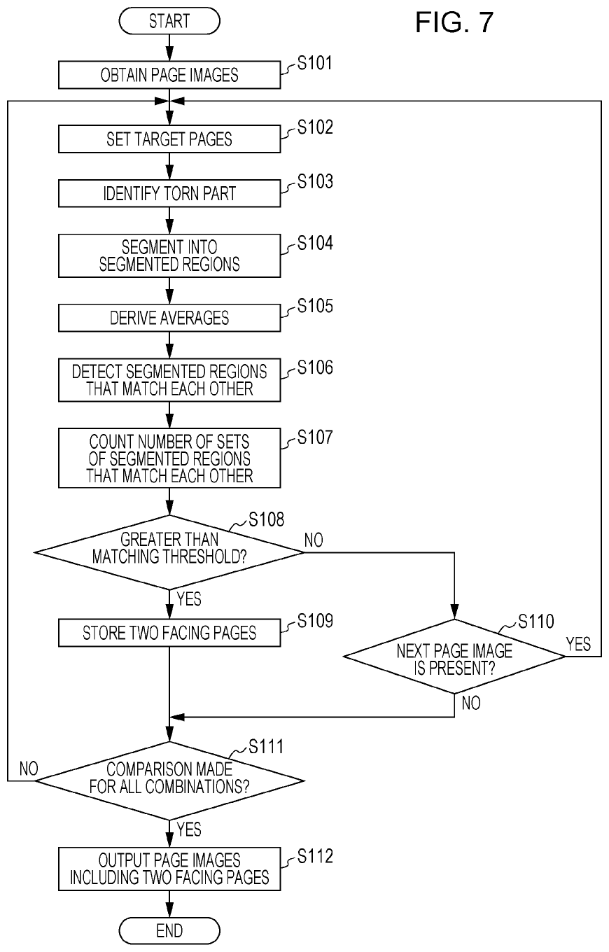

Now, operations of the information processing apparatus 10 according to this exemplary embodiment will be described with reference to FIG. 7. FIG. 7 is a flowchart illustrating an example flow of information processing according to this exemplary embodiment. The information processing illustrated in FIG. 7 is performed in response to the CPU 11 reading the information processing program from the ROM 12 or the storage 14 and executing the information processing program. The information processing illustrated in FIG. 7 is performed when page images are input and an instruction for performing the information processing is input.

In step S101, the CPU 11 obtains page images from the multifunction peripheral 2.

In step S102, the CPU 11 uses the obtained page images to set target pages.

In step S103, the CPU 11 identifies a torn part from the right-edge region 32 and the left-edge region 33 in the target pages.

In step S104, the CPU 11 segments each of the right-edge region 32 and the left-edge region 33 into the segmented regions 35.

In step S105, the CPU 11 derives the average of pixel values for each of the segmented regions 35.

In step S106, the CPU 11 compares the averages of pixel values for corresponding segmented regions 35 in the right-edge region 32 and the left-edge region 33 with each other to derive the difference between the averages, and when the difference is less than the difference threshold, detects the segmented regions 35 as the segmented regions 35 that match each other. When the torn part 34 is included in any of the segmented regions 35, the CPU 11 excludes the corresponding segmented regions 35 in the right-edge region 32 and the left-edge region 33 from comparison targets.

In step S107, the CPU 11 counts the number of sets of segmented regions 35 that match each other.

In step S108, the CPU 11 determines whether the number of sets of segmented regions 35 that match each other is greater than the matching threshold. When the number of sets of segmented regions 35 that match each other is greater than the matching threshold (step S108: YES), the CPU 11 makes the information processing proceed to step S109. On the other hand, when the number of sets of segmented regions 35 that match each other is not greater than the matching threshold (when the number of sets of segmented regions 35 that match each other is less than or equal to the matching threshold) (step S108: NO), the CPU 11 makes the information processing proceed to step S110.

In step S109, the CPU 11 stores the target pages as two facing pages.

In step S110, the CPU 11 determines whether the next page image is present. When the next page image is present (step S110: YES), the CPU 11 makes the information processing return to step S102 and sets the next page image as the right-hand page 31. On the other hand, when the next page image is not present (step S110: NO), the CPU 11 makes the information processing proceed to step S111.

In step S111, the CPU 11 determines whether a comparison is made for all combinations of page images as target pages. When a comparison for all combinations of page images has been made (step S111: YES), the CPU 11 makes the information processing proceed to step S112. On the other hand, when a comparison for all combinations of page images has not yet been made (when a combination that can be set as target pages is present) (step S111: NO), the CPU 11 makes the information processing return to step S102 and sets target pages.

In step S112, the CPU 11 combines the page images detected as two facing pages and outputs the two facing pages together with the page images.

As described above, according to this exemplary embodiment, even when a page having a torn edge part is read, two facing pages may be output.

In this exemplary embodiment, a form in which the pixel values are compared with each other for each set of corresponding segmented region 35 in the right-edge region 32 and the left-edge region 33 has been described. However, the comparison is not limited to this. The pixel values may be compared with each other for each set of corresponding pixels in the right-edge region 32 and the left-edge region 33.

In this exemplary embodiment, a form in which when the torn part 34 is identified, the segmented regions 35 that include the torn part 34 are excluded and two facing pages are detected has been described. However, the exclusion is not limited to this form. The segmented regions 35 that include the torn part 34 may be excluded depending on the size of the torn part 34. For example, the detector 24 may perform control such that when the area of the torn part 34 is larger than or equal to a predetermined area, the detector 24 excludes the segmented regions 35 that include the torn part 34, and when the area of the torn part 34 is smaller than the predetermined area, the detector 24 does not exclude the segmented regions 35 that include the torn part 34.

In this exemplary embodiment, a form in which edge parts of respective page images (the right-edge region 32 and the left-edge region 33) are compared with each other has been described. However, the comparison is not limited to this. For example, when the edge parts of respective page images are partially or entirely blank, control may be performed so as not to compare the edge parts with each other.

### Second Exemplary Embodiment

In the first exemplary embodiment, a form in which each of the right-edge region 32 and the left-edge region 33 is segmented into a predetermined number of segmented regions 35 regardless of the presence or absence of the torn part 34 has been described. In this exemplary embodiment, a form in which each of the right-edge region 32 and the left-edge region 33 from which the torn part 34 is excluded is segmented into a predetermined number of segmented regions 35 will be described.

Note that the configuration of the information processing system (see FIG. 1), the hardware configuration of the information processing apparatus 10 (see FIG. 2), the functional configuration of the information processing apparatus 10 (see FIG. 3), example page images corresponding to target pages (see FIG. 4), example page images referred to in explanation of edge parts (see FIG. 5), and example page images referred to in explanation of segmented regions (see FIG. 6) are the same as those in the first exemplary embodiment, and therefore, descriptions thereof will be omitted.

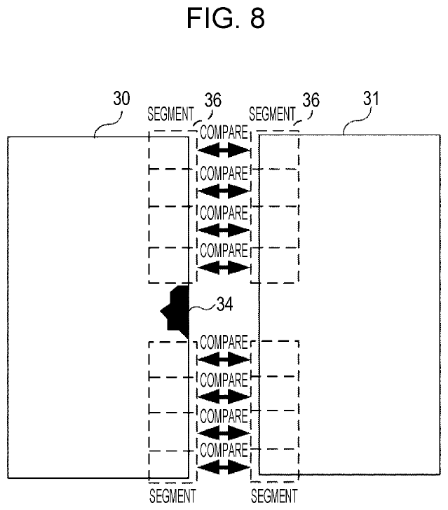

The detector 24 illustrated in FIG. 3 uses the result of identification obtained by the identifier 23 to segment each of the right-edge region 32 and the left-edge region 33 into segmented regions 36. FIG. 8 illustrates an example where the detector 24 excludes the torn part 34 and a region corresponding to the torn part 34 from the right-edge region 32 and the left-edge region 33 and segments each of the right-edge region 32 and the left-edge region 33 from which the torn part 34 and the corresponding region are excluded into a predetermined number of segmented regions 36. The detector 24 compares each set of corresponding segmented regions 36 to detect two facing pages.

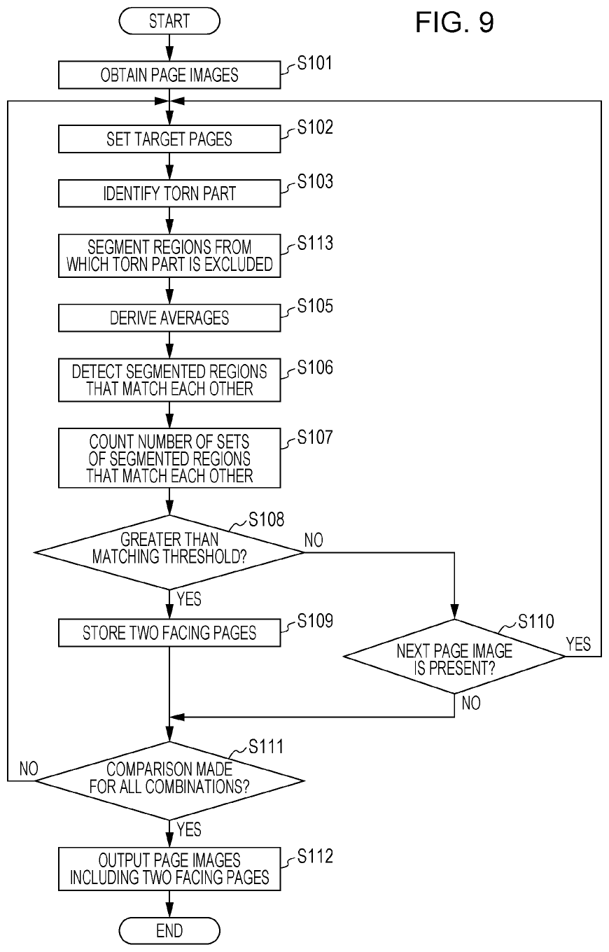

Now, operations of the information processing apparatus 10 according to this exemplary embodiment will be described with reference to FIG. 9. FIG. 9 is a flowchart illustrating an example flow of information processing according to this exemplary embodiment. The information processing illustrated in FIG. 9 is performed in response to the CPU 11 reading the information processing program from the ROM 12 or the storage 14 and executing the information processing program. The information processing illustrated in FIG. 9 is performed when page images are input and an instruction for performing the information processing is input. Note that in FIG. 9, a step the same as that in the information processing illustrated in FIG. 7 is assigned a reference numeral the same as that in FIG. 7, and a description thereof will be omitted.

In step S113, the CPU 11 segments each of the right-edge region 32 and the left-edge region 33 from which the torn part 34 and a region corresponding to the torn part 34 are excluded into a predetermined number of segmented regions 36.

As described above, according to this exemplary embodiment, two facing pages may be detected regardless of the size of the torn part more accurately than in a case where the number of sets of segmented regions to be compared with each other differs depending on the torn part.

In this exemplary embodiment, a form in which the number of segmented regions 36 is determined in advance has been described. However, the number is not limited to this. The number of segmented regions 36 may be set in accordance with the area of the torn part 34.

### Third Exemplary Embodiment

In the first exemplary embodiment and the second exemplary embodiment, a form in which two facing pages are detected while a region corresponding to the torn part 34 is excluded has been described. In this exemplary embodiment, a form in which two facing pages are detected while a region corresponding to the torn part 34 is included will be described.

Note that the configuration of the information processing system (see FIG. 1), the hardware configuration of the information processing apparatus 10 (see FIG. 2), example page images corresponding to target pages (see FIG. 4), example page images referred to in explanation of edge parts (see FIG. 5), and example page images referred to in explanation of segmented regions (see FIG. 6) are the same as those in the first exemplary embodiment, and therefore, descriptions thereof will be omitted. Further, example page images (see FIG. 8) referred to in explanation of segmented regions from which the torn part is excluded are the same as those in the second exemplary embodiment, and therefore, a description thereof will be omitted.

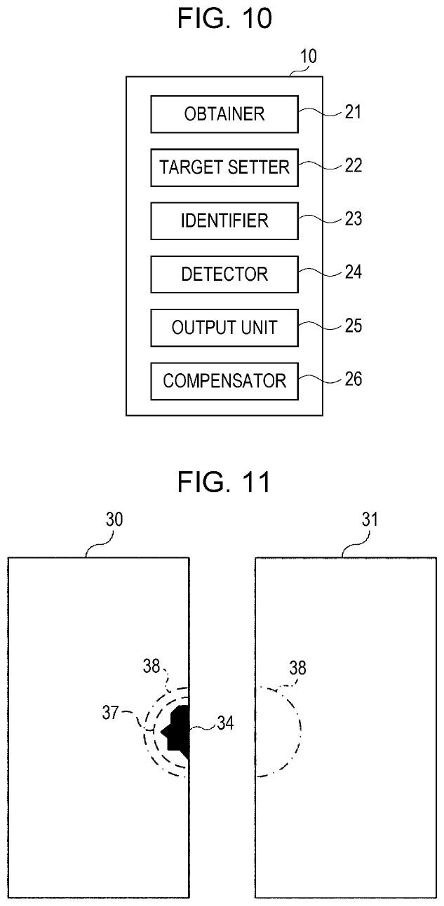

First, the functional configuration of the information processing apparatus 10 will be described with reference to FIG. 10. FIG. 10 is a block diagram illustrating an example functional configuration of the information processing apparatus 10 according to this exemplary embodiment. Note that in FIG. 10, a functional component the same as that in the information processing apparatus illustrated in FIG. 3 is assigned a reference numeral the same as that in FIG. 3, and a description thereof will be omitted.

FIG. 10 illustrates an example where the information processing apparatus 10 includes the obtainer 21, the target setter 22, the identifier 23, the detector 24, the output unit 25, and a compensator 26. The CPU 11 executes the information processing program to thereby function as the obtainer 21, the target setter 22, the identifier 23, the detector 24, the output unit 25, and the compensator 26.

The compensator 26 compensates for the torn part 34 identified by the identifier 23. FIG. 11 illustrates a specific example where the compensator 26 derives the average of the pixel values of pixels included in a range (hereinafter referred to as “first range”) 37 predetermined by assuming the torn part 34 to be the base point and applies the derived average as the pixel values in the torn part 34 to thereby compensate for the torn part 34 in a page image. Further, the compensator 26 derives the average of the pixel values of pixels included in a range (hereinafter referred to as “second range”) 38 predetermined by assuming the torn part 34 to be the base point and applies the derived average as the pixel values in the torn part 34 to thereby compensate for the torn part 34 in detected two facing pages.

That is, when the torn part 34 is identified in one page image, the compensator 26 compensates for the torn part 34 by using the pixel values of pixels in the first range 37. When the torn part 34 is included in detected two facing pages, the compensator 26 further compensates for the torn part 34 by using the pixel values of pixels in the second range 38.

A form in which the first range 37 and the second range 38 according to this exemplary embodiment are predetermined has been described. However, the first range 37 and the second range 38 are not limited to this form. The first range 37 and the second range 38 may be determined by the user or may be set in accordance with the area of the torn part 34. Alternatively, the segmented regions 36 in the page images may be set as the first range 37 and the second range 38.

In this exemplary embodiment, a form in which the torn part 34 is compensated for regardless of the state of the torn part 34 has been described. However, the compensating is not limited to this form. The torn part 34 may be compensated for in accordance with the size of the torn part 34. For example, the compensator 26 may perform control such that when the area of the torn part 34 is larger than or equal to a predetermined area, the compensator 26 compensates for the torn part 34, and when the area of the torn part 34 is smaller than the predetermined area, the compensator 26 does not compensate for the torn part 34.

In this exemplary embodiment, a form in which the pixel values in the torn part 34 are compensated for has been described. However, the compensating is not limited to this form. The outline of the torn part 34 may be compensated for. In this exemplary embodiment, a form in which the torn part 34 is compensated for by using the average of pixel values has been described. However, the compensating is not limited to this form. The torn part 34 may be compensated for by using the median and the mode of pixel values.

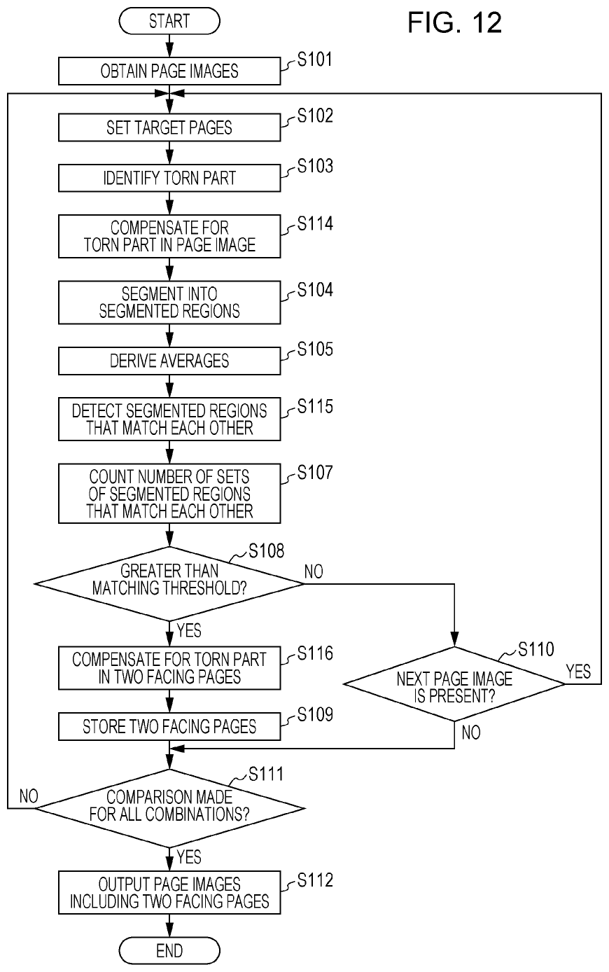

Next, operations of the information processing apparatus 10 according to this exemplary embodiment will be described with reference to FIG. 12. FIG. 12 is a flowchart illustrating an example flow of information processing according to this exemplary embodiment. The information processing illustrated in FIG. 12 is performed in response to the CPU 11 reading the information processing program from the ROM 12 or the storage 14 and executing the information processing program. The information processing illustrated in FIG. 12 is performed when page images are input and an instruction for performing the information processing is input. Note that in FIG. 12, a step the same as that in the information processing illustrated in FIG. 7 is assigned a reference numeral the same as that in FIG. 7, and a description thereof will be omitted.

In step S114, the CPU 11 compensates for the torn part 34 by using the pixel values of pixels included in the first range 37 that is based on the torn part 34, in the identified page image.

In step S115, the CPU 11 compares the averages of pixel values for corresponding segmented regions 35 in the right-edge region 32 and the left-edge region 33 with each other to derive the difference between the averages, and when the difference is less than the difference threshold, detects the segmented regions 35 as the segmented regions 35 that match each other. As the difference threshold for the segmented regions 35 that include the torn part 34, a value larger than the difference threshold that is applied to the segmented regions 35 that do not include the torn part 34 is set. When the difference threshold is changed in accordance with the presence or absence of the torn part 34, two facing pages are detected by taking into consideration the pixel values in the torn part 34.

In step S116, the CPU 11 compensates for the torn part 34 by using the pixel values of pixels included in the second range 38 determined by assuming the torn part 34 as the base point, in the detected two facing pages.

As described above, according to this exemplary embodiment, two facing pages may be detected while the torn part 34 is included.

Note that in the above-described exemplary embodiments, a form in which the torn part 34 is excluded has been described in the first exemplary embodiment and the second exemplary embodiment, and a form in which the torn part 34 is compensated for has been described in the third exemplary embodiment. However, the processing is not limited to these forms. An exemplary embodiment to be employed may be switched between the above-described exemplary embodiments in accordance with processing desired by the user. For example, when the user desires processing in which the speed takes precedence over others, the processing in the first exemplary embodiment may be performed, when the user desires processing in which accuracy takes precedence over others, the processing in the second exemplary embodiment may be performed, and when the user desires output of two facing pages that look natural, the processing in the third exemplary embodiment may be performed.

Although the present disclosure has been described with reference to exemplary embodiments, the present disclosure is not limited to the scope described in the exemplary embodiments. Various changes or modifications can be made to any of the exemplary embodiment without departing from the spirit of the present disclosure, and the exemplary embodiment to which the changes or modifications has been made is also within the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Although a form in which the information processing program is installed in a storage has been described in the exemplary embodiments, the information processing program is not limited to this form. The information processing program according to the exemplary embodiments may be recorded to a computer-readable storage medium and provided. For example, the information processing program according to the exemplary embodiments of the present disclosure may be recorded to an optical disc, such as a CD (Compact Disc)-ROM or a DVD (Digital Versatile Disc)-ROM, and provided. The information processing program according to the exemplary embodiments of the present disclosure may be recorded to a semiconductor memory, such as a USB (Universal Serial Bus) memory or a memory card, and provided. The information processing program according to the exemplary embodiments may be obtained from an external apparatus via a communication line connected to the communication I/F.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to:
   obtain a plurality of page images obtained by reading pages;
   identify, in two page images that are target pages among the plurality of page images, a torn part in edge parts adjacent to each other when the target pages are two facing pages that show one image; and
   detect and output the two facing pages by using an obtained result of identification.
      (((2)))

The information processing apparatus according to (((1))), wherein:
the processor is configured to:
detect the two facing pages while compensating for the torn part in accordance with the result of identification.
   (((3)))

The information processing apparatus according to (((2))), wherein:
the processor is configured to:
compensate for the torn part by using pixel values in a first range that is predetermined by assuming the torn part to be a base point.
   (((4)))

The information processing apparatus according to (((3))), wherein:
the processor is configured to:
when the torn part has been compensated for, further compensate for the torn part in the two facing pages by using pixel values in a second range that is predetermined by assuming the torn part to be a base point.
   (((5)))

The information processing apparatus according to any one of (((1))) to (((4))), wherein:
the processor is configured to:
identify, in the edge parts, at least one of a part in which an outline is lost or a part in which a feature value related to a predetermined color is detected, as the torn part.
   (((6)))

The information processing apparatus according to (((5))), wherein:
the processor is configured to:
detect the two facing pages while excluding the torn part in accordance with the result of identification.
   (((7)))

The information processing apparatus according to (((6))), wherein:
the processor is configured to:
exclude the torn part when the torn part has an area that is larger than or equal to a predetermined threshold.
   (((8)))

The information processing apparatus according to any one of (((1))) to (((7))), wherein:
the processor is configured to:
identify the two facing pages by making a comparison between pixel values in the edge parts.
   (((9)))

The information processing apparatus according to (((8))), wherein:
the processor is configured to:
make the comparison for each set of pixels or each set of segmented regions obtained by segmenting the edge parts.
   (((10)))

The information processing apparatus according to (((9))), wherein:
the processor is configured to:
make the comparison by using as a pixel value in each segmented region, an average of pixel values of pixels included in the segmented region.
   (((11)))

The information processing apparatus according to (((9))), wherein:
the processor is configured to:
segment a region obtained by excluding the torn part from the edge parts, into a predetermined number of segmented regions and compare the segmented regions with each other.
   (((12)))

An information processing program causing a computer to execute a process comprising:
obtaining a plurality of page images obtained by reading pages;
identifying, in two page images that are target pages among the plurality of page images, a torn part in edge parts adjacent to each other when the target pages are two facing pages that show one image; and
detecting and outputting the two facing pages by using an obtained result of identification.

What is claimed is:

1. An information processing apparatus comprising:
a processor configured to:
obtain a plurality of page images obtained by reading pages;
identify, in two page images that are target pages among the plurality of page images, a torn part in edge parts adjacent to each other when the target pages are two facing pages that show one image; and
detect and output the two facing pages by using an obtained result of identification.

2. The information processing apparatus according to claim 1, wherein:
the processor is configured to:
detect the two facing pages while compensating for the torn part in accordance with the result of identification.

3. The information processing apparatus according to claim 2, wherein:
the processor is configured to:
compensate for the torn part by using pixel values in a first range that is predetermined by assuming the torn part to be a base point.

4. The information processing apparatus according to claim 3, wherein:
the processor is configured to:
when the torn part has been compensated for, further compensate for the torn part in the two facing pages by using pixel values in a second range that is predetermined by assuming the torn part to be a base point.

5. The information processing apparatus according to claim 1, wherein:
the processor is configured to:
identify, in the edge parts, at least one of a part in which an outline is lost or a part in which a feature value related to a predetermined color is detected, as the torn part.

6. The information processing apparatus according to claim 5, wherein:
the processor is configured to:
detect the two facing pages while excluding the torn part in accordance with the result of identification.

7. The information processing apparatus according to claim 6, wherein:
the processor is configured to:
exclude the torn part when the torn part has an area that is larger than or equal to a predetermined threshold.

8. The information processing apparatus according to claim 1, wherein:
the processor is configured to:
identify the two facing pages by making a comparison between pixel values in the edge parts.

9. The information processing apparatus according to claim 8, wherein:
the processor is configured to:
make the comparison for each set of pixels or each set of segmented regions obtained by segmenting the edge parts.

10. The information processing apparatus according to claim 9, wherein:
the processor is configured to:
make the comparison by using as a pixel value in each segmented region, an average of pixel values of pixels included in the segmented region.

11. The information processing apparatus according to claim 9, wherein:
the processor is configured to:
segment a region obtained by excluding the torn part from the edge parts, into a predetermined number of segmented regions and compare the segmented regions with each other.

12. A non-transitory computer readable medium storing a program causing a computer to execute a process for information processing, the process comprising:
obtaining a plurality of page images obtained by reading pages;
identifying, in two page images that are target pages among the plurality of page images, a torn part in edge parts adjacent to each other when the target pages are two facing pages that show one image; and
detecting and outputting the two facing pages by using an obtained result of identification.

13. An information processing method comprising:
obtaining a plurality of page images obtained by reading pages;
identifying, in two page images that are target pages among the plurality of page images, a torn part in edge parts adjacent to each other when the target pages are two facing pages that show one image; and
detecting and outputting the two facing pages by using an obtained result of identification.
